(19) United States
(12) Patent Application Publication
(10) Pub. No.: US 2010/0132251 A1
(43) Pub. Date: Jun. 3, 2010

(54) METHOD FOR PURIFICATION OF BIODIESEL

(76) Inventors: Ulrich Sohling, Freising (DE); Friedrich Ruf, Ast (DE); Jose Antonio Ortiz Niembro, Pue (DE); Rosalina Condemarin, Lima (PE); Jorge Bello, Pue (MX)

Correspondence Address: RATNERPRESTIA, P.O. BOX 980, VALLEY FORGE, PA, 19482, US

(21) Appl. No.: 12/513,440

(22) PCT Filed: Nov. 7, 2007
(86) PCT No.: PCT/EP07/09656

§ 371 Date: Jan. 27, 2010

(30) Foreign Application Priority Data
Nov. 7, 2006 (EP) 06023142.0
Aug. 19, 2007 (EP) 07016241.7

(51) Int. Cl. C10L 1/19

(52) U.S. Cl. 44/388

(57) ABSTRACT

The invention pertains to a method for purifying crude biodiesel, wherein said crude biodiesel is contacted with a clay material, said clay material having: a surface area of more than 120 m2/g; a total pore volume of more than 0.35 ml/g; a silicon content, calculated as Siθ2, of at least 60 wt.-%.

The invention relates to a method for purification of biodiesel.

Due to their neutral carbon dioxide balance and improved production processes biodiesel attracts increasing attention as an alternative to conventional petrochemical diesel fuel. In some countries, e.g. within the European Union, diesel fuel must contain a defined amount of biodiesel.

Biodiesel is derived from triglycerides by a transesterification or alcoholysis reaction in which one mole of triglyceride reacts with three moles of alcohol to form one mole of glycerol and three moles of the respective fatty acid alkyl ester. The process is a sequence of three reversible reactions, in which the triglyceride in a step by step reaction is transformed into diglyceride, monoglyceride and glycerol. In each step one mole of alcohol is consumed and one mole of the corresponding fatty acid ester is produced. In most processes performed on industrial scale, methanol is used as the alcohol. However, also biodiesel comprising an ethyl or propyl fatty acid ester is commercially available. In order to shift the equilibrium towards the fatty acid alkyl ester side, the alcohol, in particular methanol, is added in an excess over the stoichiometric amount in most commercial biodiesel production plants. A further advantage of the methanolysis of triglycerides is in that during the reaction glycerol and fatty acid methyl ester is produced as the main products, which are hardly miscible and thus form separate phases with an upper ester phase and a lower glycerol phase. By removing glycerol from the reaction mixture a high conversion rate may be achieved. The transesterification may be performed as a single step process or a multi step process. In the latter process only a portion of the required methanol is added in each step and the glycerol phase is separated after each process step. Methanol has only a poor solubility in oils and fats and, therefore, in the beginning of the transesterification process the upper methanol phase and the lower oil phase have to be mixed thoroughly. During methanolysis fatty acid methyl esters are produced which are readily miscible with methanol. Further, partial glycerides and soaps may act as emulsifiers between the starting materials and thus, the reaction mixture becomes homogenous after an initial induction period. In the further course of the reaction increasing amounts of glycerol are produced which are not miscible with the fatty acid methyl esters and, therefore, a phase separation is established with an upper ester phase and a lower glycerol phase.

The alcoholysis of triglycerides is catalysed by an alkaline or an acidic catalyst. Alkaline catalysis is by far the most commonly used reaction type for commercial biodiesel production. Alkaline catalysed transesterification may be performed advantageously under mild conditions and high conversion rates and, therefore, requires comparatively short reaction times. Moreover, basic catalysts are less corrosive to industrial equipment, so that they enable the use of less expensive carbon-steel material. In most commercial biodiesel production plants transesterification is performed with homogenous alkaline catalysis. The alkoxide anion required for the reaction is produced by directly dissolving an alkali alcoholate in the alcohol, by reacting the alcohol with pure alkali metal or, in case of methanolysis, by adding an alkali hydroxide to the methanol. Due to the fast separation of the glycerol phase in alcoholysis of triglycerides most of the alkaline catalyst is removed from the reaction mixture and, thus, the produced fatty acid esters will hardly get into contact with the hydroxide and, therefore, only a low tendency for soap formation exists. The catalyst is usually added in an amount of about 0.5 to 1.0% based on the weight of the oil. Details to the manufacturing of Biodiesel may be found at M. Mittelbach, C. Remschmidt, “Biodiesel The comprehensive Handbook”, Graz, 2004; ISBN 3-200-00249-2.

Triglycerides used as starting materials in the biodiesel production may be obtained e.g. from plant sources or animal fat sources. Four oil crops dominate the feedstock sources used for the world-wide biodiesel production with rapeseed oil by far leading followed by sunflower seed oil, soybean oil and palm oil. Other sources of commercial interest are linseed oil, beef tallow and recycled frying oil.

To achieve a defined combustion of the biodiesel it is necessary to decrease the amount of residual mono-, di-, and triglycerides as well as of soaps and glycerol as far as possible. According to DIN EN 14214, biodiesel may contain up to 0.2 wt.-% monoglycerides, up to 0.8 wt.-% diglycerides and up to 0.2 wt.-% triglycerides. Further, soaps formed during the transesterification must be removed from the biodiesel fuel because otherwise the fuel would leave a residual ash upon combustion which might e.g. be harmful to parts of a diesel internal combustion engine. In usual practice therefore a water wash is performed to remove soaps as well as residual methanol, glycerol and mono- and diglycerides. When large amounts of soap are present in the crude biodiesel, a stable emulsion may form and separation of the fatty acid esters may become difficult.

In WO 2005/037969 A2 is described a method of purifying biodiesel fuel, comprising contacting said biodiesel fuel with at least one adsorbent material. The adsorbent material is preferably magnesium silicate, particularly preferred an amorphous hydrous precipitated synthetic magnesium silicate, said magnesium silicate having been treated to reduce the pH thereof to less than about 9.0. By use of such adsorbents most of the contaminants may be removed from the biodiesel.

In US 2005/0188607 A1 is disclosed a method for removing methanol and other substances from crude biodiesel, including mixing a silicone based adsorbent with crude biodiesel. The silicon based adsorbent preferably is a magnesium silicate.

Magnesium silicate suggested for use in purification of crude biodiesel is a synthetic product. The synthesis of this adsorbent therefore requires costly educts as well as energy and synthesis apparatuses. Further, during magnesium silicate synthesis is produced waste material which has to be recycled or deposited in a controlled environment.

The problem to be solved by the invention therefore is in that to provide a method for purification of crude biodiesel which does not utilize costly adsorbents and provides a purified biodiesel in accordance with purity requirements for use of such biodiesel e.g. in internal combustion engines.

This problem is solved by a method according to claim 1. Preferred embodiments are defined in the depending claims.

In the purification method according to the invention is used a particular clay material that has very high surface area of more than 120 m²/g, preferably more than 150 m²/g. According to an embodiment of the invention, the clay material has a surface area of less than 300 m²/g. According to a further embodiment, the surface area is less than 280 m²/g. Further, the clay material has a very high total pore volume of more than 0.35 ml/g. Further, the clay material used in the method according to the invention has a very high silicon content, calculated as SiO₂, of at least 60 wt.-%, more preferred of more than 63 wt.-%, particularly preferred of more than 65 wt.-% and most preferred of at least 70 wt.-%. According to an embodiment, the silicon content of the clay material is less than 85 wt.-%. According to a further embodiment, the silicon content, calculated as SiO₂, is less than 75 wt.-%.

It is known, that clay materials may adsorb mono-alcohols, glycols, as well as glycerols. For example, the enlargement of the layer spacing when treating smectite particles with ethylglycol or glycerol is a common method for the identification of smectites in unknown mineral samples and is also used e.g. to differentiate smectites from vermiculites. By introduction of glycol or glycerol molecules into the interlayer spaces the distance between individual layers is increased to 17 to 18 Å which enlargement can be detected by X-ray diffraction. Vermiculites do not exhibit swelling after treatment with glycol or glycerol. Smectites are 2=1 type layered silicates with a layer charge of 0.2 to 0.6 per formula unit. Typical smectites are montmorillonite, beidellite, saponite, hectorite, nontronite and stevensite.

With the clay materials used in the method according to the invention it has been found a much better purification performance when compared to commonly used clay minerals, in particular smectites. With the clay material as used in the method according to the invention, a much better and faster removal of glycerol, monoglycerides and diglycerides from crude biodiesel is achieved than with smectite minerals, e.g. bentonite.

The clay material used in the method of the invention has a very high silicon content which is well above the silicon content of e.g. bentonite. Therefore, the clay material does not have such a well ordered structure as layered silicates, e.g. bentonite, but preferably comprises large amounts of amorphous material. Such amorphous material is believed to be formed by amorphous SiO₂.

According to a preferred embodiment, the clay material used in the method according to the invention consists of a mixture of a smectitic clay and an amorphous silica phase. Such clay material does not have a well ordered structure as found in usual clay minerals, like bentonite or attapulgite but comprises besides a smectitic clay phase an amorphous silica phase. The clay material is homogenous on a macroscopic scale, i.e. is a intimate mixture of both phases. The presence of a smectitic phase can be detected by the methylene blue adsorption test described further below. The inventors believe, that the clay material used in the method of the invention comprises a continuous phase of amorphous silica into which are inserted small platelet-shaped smectite phases. The platelets of the smectite phase are homogeneously distributed in the continuous amorphous silica phase and firmly fixed therein. The structure of the clay material therefore differs from clay minerals, as e.g. used as natural bleaching earth for the purification of oils, which are layered silicates and do not comprise large amounts of an amorphous phase formed of silica. This type of clay material used in the method according to the invention may therefore be considered as a new class of clay minerals which until now did not find a broad application as adsorbent material.

With the method according to the invention it is possible to reduce the residual amount of glycerol, water and soaps as well as of mono- and diglycerides present in crude biodiesel below limits defined in international norms, e.g. norms valid in the U.S. or the European Union. In many cases it is not even necessary to perform a water wash step before treating the crude biodiesel with the above defined clay material. Further, in many cases it is not necessary to purify, in particular refine, bleach and/or deodorize the crude oil used as starting material for alcoholysis of triglycerides.

Although not wanting to be bound by that theory the inventors believe that the clay material used in the purification method according to the invention comprises a matrix-like network of amorphous SiO₂ into which very small clay particles are inserted and which may provide a high adsorption capacity for impurities contained in crude biodiesel.

The clay material used for purification of crude biodiesel may be a synthetic material. Preferably, however, is used a clay material provided from a natural source. Such clay materials can be provided very easily and at comparatively low cost, e.g. from a respective mine. The clay material used in the method of the invention therefore does not require expensive materials or causes high energy consumption for its synthesis.

Preferably, clay materials are used that have a very high surface area of 180 to 300 m²/g, more preferred 185 to 280 m²/g, particularly preferred 190 to 250 m²/g as determined by the BET method. Further, the clay material used in the method according to the invention may preferably have a very high total pore volume of more than 0.5 ml/g, particularly preferred more than 0.55 ml/g, most preferred more than 0.6 ml/g. The pore volume of the clay material used in the method of the invention according to a first embodiment is less than 1.2 ml/g. According to a further embodiment the pore volume is less than 1.0 ml/g and according to a still further embodiment is less than 0.9 ml/g.

The large pore volume is believed to allow a rapid access of the crude biodiesel to the small clay particles and, therefore, an efficient purification of the crude biodiesel fuel. It is believed, that the advantageous behaviour of the clay material used in the method according to the invention is based on kinetic effects. In the clay minerals hitherto used as adsorbent material only the outer surface of the clay particles is available for a fast adsorption of molecules, e.g. glycerol as well as mono- and diglycerides. Such outer surface is much smaller than the inner surface of clay minerals as e.g. determined by BET-methods. During adsorption, the molecules, e.g. glycerol etc., are intercalated between layers in the crystal structure of the clay mineral and the interlayer distance is increased. The clay mineral therefore swells upon adsorption of molecules like glycerol. The swelling starts at the outer surface of the clay particles thereby blocking or at least rendering difficult the access of further molecules to be adsorbed to the inner parts of the clay particles. In swelling experiments, complete swelling of smectites with diols may take several days.

Contrary to this hitherto used clay minerals the clay material as used in the method according to the invention comprises a matrix of amorphous SiO₂ into which are inserted small particles of smectite minerals. The smectite particles are delaminated to a high degree and therefore provide a very high surface area for adsorption of molecules, e.g. glycerol etc. The SiO₂-matrix is believed to be quite rigid, i.e. the clay material does hardly swell upon adsorption of e.g. glycerol as well as mono- and diglycerides. Through the large pores provided in the clay material, which are in particular situated in the SiO₂-matrix, a rapid access of the crude biodiesel to the clay particles inserted in the SiO₂-matrix is possible throughout the purification process since the clay material does hardly swell during adsorption of glycerol and other polar compounds present in the crude biodiesel. This effects a considerable smaller slowing down of the adsorption speed in comparison to the application of the hitherto used clay minerals.

For biodiesel production fast purification processes are needed. In an industrial process the contact time between the crude biodiesel and the adsorbent may be within a range of minutes to hours. The clay material used in the method according to the invention allows a very fast and efficient adsorption of impurities from crude biodiesel due to its special crystal structure which allows a rapid access of the impurities to the small clay particles fixed within a rigid SiO₂ matrix. Although a smaller amount of smectite clay may be present in the clay material used in the method according to the invention, when compared to hitherto used clay adsorbents, e.g. bentonite, a much better adsorbent performance is achieved.

As already discussed above, the clay material used in the purification method according to the invention has not a typical clay structure but seems to comprise a quite rigid SiO₂ matrix into which are inserted and fixed very small clay particles or platelets.

Preferably, the clay material used in the method according to the invention comprises at least 10 wt.-%, particularly preferred more than 20 wt.-% and most preferred more than 30 wt.-% of an amorphous phase. According to an embodiment of the invention, the amorphous phase forms less than 90 wt.-%, according to a further embodiment less than 80 wt.-% of the clay material. The amorphous phase is preferably formed from SiO₂. Besides the amorphous phase, the clay material used in the method of the invention preferably comprises a smectite phase. The clay material preferably comprises less than 60 wt.-%, more preferred less than 50%, particularly preferred less than 40 wt.-% of a smectite phase. According to an embodiment of the invention, the smectite phase forms at least 10 wt.-%, according to a further embodiment at least 20 wt.-% of the clay material. The ratio smectite phase/amorphous phase preferably is within an range of 2 to 0.5, more preferred 1.2 to 0.8.

Besides the amorphous phase and the smectite phase further minerals may be present in the clay material, preferably within a range of 0.5 to 40 wt.-%, more preferred 1 to 30 wt.-%, particularly preferred 3 to 20 wt.-%. Exemplary side minerals are quartz, cristobalite, feldspar and calcite. Other side minerals may also be present.

The structure of the clay material used in the method according to the invention may be detected by various experimental methods.

As explained above, in the clay material used in the method according to the invention, the matrix preferably formed from silica gel dilutes the smectite phase which leads, depending on the fraction of the smectite phase, to a lowering of the signal-to-noise ratio of typical reflections of smectite minerals. E.g. the small angle reflections of montmorillonite are effected by the periodic distance between layers of the montmorillonite structure. Further, the clay particles fixed in the SiO₂-matrix are delaminated to a very high degree leading to a strong broadening of the corresponding diffraction peak.

In an XRD-diffractogram of the clay material used in the method of the invention the reflexes are hardly visible above noise. The ratio signal noise for reflexes regarding the clay material, in particular the smectite phase, is according to an embodiment of the invention close to 1 and may be according to a further embodiment within a range of 1 to 1.2. However, sharp reflexes may be visible in the diffractogram originating from impurities of the clay material, e.g. quartz. Such reflexes are not considered for determination of the signal/noise ratio.

Preferably a clay material is used in the method of the invention, which does not or does hardly show a 001 reflection indicating the layer distance within the crystal structure of bentonite particles. Hardly visible means that the signal-to-noise ratio of the 001 reflection of the smectite particles is preferably less than 1.2, particularly preferred is within a range of 1.0 to 1.1.

According to an embodiment, the clay material may have an amorphous structure according to XRD data.

The amount of amorphous silica phase and smectite clay mineral phase present in the clay material used in the method according to the invention may be determined by quantitative X-ray-diffraction analysis. Details of such method are described e.g. in “Hand Book of Clay Science”, F. Bergaya, B. K. G. Therry, G. Lagaly (Eds.), Elsevier, Oxford, Amsterdam, 2006, Chapter 12.1: I. Srodon, Identification and Quantitative Analysis of Clay Minerals; “X-Ray Diffraction and the Identification and Analysis of Clay Minerals”, D. M. Moora and R. C. Reaynolds, Oxford University Press, New York, 1997, pp 765, included herein by reference.

Quantitative X-ray diffraction is based on the Rietveld refinement formalism. This algorithm was originally developed by H. M. Rietveld for the refinement of crystal structures. The method is now commonly used in mineralogy and e.g. the cement industry for quantification of mineral phases in unknown samples.

The Rietveld refinement algorithm is based on a calculated fit of a simulated diffraction pattern on a measured diffractogram. First, the mineral phases are determined by assigning peaks of the diffractogram. Based on the minerals determined, the diffractogram is then calculated based on the crystal structure of the minerals present in the sample as well as on equipment and sample specific parameters. In the next steps, the parameters of the model are adjusted to get a good fit of the calculated and the measured diffractogram, e.g. by using the least square-fit method. Details of the method are e.g. described in R. A. Young: “The Rietveld Method”, Oxford University Press, 1995. The Rietveld method is able to deal reliably with strongly overlapping reflections in the diffractogram.

For application of this method to the analysis of mineral samples, see e.g. D. K. McCarthy “Quantitative Mineral Analysis of Clay-bearing Mixtures”, in: “The Reynolds Cup” Contest. IUCr CPD Newsletter, 27, 2002, 12-16.

In practice the quantitative determination of the different minerals in unknown samples is done by commercially available software, e.g. “Seifert AutoQuan” available from Seifert/GE Inspection Technologies, Ahrensburg, Germany.

The clay material used in the purification method according to the invention preferably does hardly swell when deposited in water. It therefore may be separated from the biodiesel fuel with ease after the purification procedure. Preferably the clay material has a sediment volume in water after 1 h of less than 15 ml/2 g, more preferred of less than 10 ml/2 g, particularly preferred of less than 8 ml/2 g, and most preferred of less than 7 ml/2 g.

The clay material, in particular when mined from a natural source, preferably has a cation exchange capacity of more than 40 meq/100 g, particularly preferred of more than 45 meq/100 g and is most preferred selected within a range of 44 to 70 meq/100 g. High activity bleaching earth obtained by extracting a clay mineral with boiling strong acid is characterized by a very low cation exchange capacity of usually less than 40 meq/100 g and in most cases of less than 30 meq/100 g. The clay material used in the method according to the invention therefore can clearly be distinguished from such high performance bleaching earth.

So-called surface modified bleaching earths exhibit a similar cation exchange capacity as the clay material used in the method according to the invention. Such surface activated bleaching earths, however, have a much lower pore volume and, therefore, can clearly be distinguished from the clay material as used in the method of the invention. Such surface modified bleaching earth does not allow an easy access of the crude biodiesel to the inner parts of the clay particle since those clay materials swell as described above and therefore block a further access of the crude biodiesel to the interlayer spaces of the layered silicate. The adsorption speed of such surface activated bleaching earth therefore is low.

The clay material used in the method according to the invention is characterized by a high content of SiO₂. Besides silicon other preferred metals or metal oxides may be contained in the clay material. All percentages refer to a dry clay material dried to constant weight at 105° C.

The clay material preferably has a low aluminium content of, calculated as Al₂O₃, less than 15 wt.-%, more preferred of less than 12 wt.-%, particularly preferred of less than 11 wt.-% and most preferred of less than 10 wt.-%. The aluminium content, calculated as Al₂O₃, according to an embodiment is more than 2 wt.-%, according to a further embodiment more than 4 wt.-%, according to a further embodiment is more than 6 wt.-% and according to a still further embodiment is more than 8 wt.-%.

According to a further embodiment the clay material contains magnesium, calculated as MgO, in an amount of less than 7 wt.-%, preferably of less than 6 wt.-%, particularly preferred less than 5 wt.-%. According to an embodiment of the invention, the clay material contains magnesium, calculated as MgO, in an amount of at least 0.5 wt.-%, particularly preferred at least 1.0 wt.-%. According to a further embodiment, the clay material contains at least 2 wt.-% MgO.

According to an embodiment, the clay material may contain iron, calculated as Fe₂O₃, in amount of less than 8 wt.-%. According to a further embodiment, the iron content, calculated as Fe₂O₃, may be less than 6 wt.-% and according to a still further embodiment may be less than 5 wt.-%. According to a further embodiment, the clay material may contain iron, calculated as Fe₂O₃, in an amount of at least 1 wt.-%, and according to a still further embodiment in an amount of at least 2 wt.-%.

The inventors believe, that the distribution of the pore diameter has a considerable effect on the activity of the adsorbent. In a first embodiment of the method of the invention, to obtain a high adsorption activity, it is preferred that a clay material is used which is characterized in that at least 60%, preferably 65 to 70% of the total pore volume of the clay material is provided by pores having a pore diameter of at least 140 Å, at least 40%, preferably at least 50%, particularly preferred 55 to 60% of the total pore volume is provided by pores having a pore diameter of less than 250 Å, and at least 15%, more preferred at least 20%, particularly preferred 21 to 25% of the total pore volume is provided by pores having a pore diameter of 140 to 250 Å. Preferably less than 20% of the total pore volume, particularly preferred less than 15%, most preferred 10 to 14% of the total pore volume is formed by pores having a diameter of >800 Å.

Further preferred, at least 20%, preferably at least 25%, particularly preferred at least 30% and most preferred 33 to 40% of the total pore volume of the clay material is provided by pores having a pore diameter of less than 140 Å.

Further preferred, at least 10%, preferably at least 13%, particularly preferred 15 to 20% of the total pore volume of the clay material according to the first embodiment of the method according to the invention is provided by pores having a pore diameter of 75 to 140 Å.

Still further preferred, less than 40%, preferably less than 35%, particularly preferred 25 to 33% of the total pore volume of the clay material is formed by pores having a pore diameter of 250 to 800 Å.

In the clay material used in the first embodiment of the method according to the invention, preferably at least 12%, particularly preferred at least 14%, most preferred 15 to 20% of the total pore volume is provided by pores having a pore diameter of less than 75 Å.

Further, preferably less than 80%, more preferred less than 75%, particularly preferred 60 to 70% of the total pore volume of the clay material is formed by pores having a pore diameter of more than 140 Å.

Further preferred, less than 60%, preferably less than 50%, particularly preferred 40 to 45% of the total pore volume of the clay material is formed by pores having a pore diameter of at least 250 Å.

Preferred ranges of the total pore volume in relation to the pore diameter are summarized in the following table 1:

TABLE 1
preferred percentages of the total pore volume formed by pores
of a distinct pore diameter for a clay material used in a first
embodiment of the purification method according to the invention

| | | | particularly | |
|---|---|---|---|---|
| pore diameter | | preferred | preferred | most preferred |
| 0-75 | Å | >12% | >14% | 15-20% |
| 75-140 | Å | >10% | >13% | 15-20% |
| 140-250 | Å | >15% | >20% | 21-25% |
| 250-800 | Å | <40% | <35% | 25-33% |
| >800 | Å | <20% | <15% | 10-14% |

According to a second embodiment a clay material is used in the method according to the invention in which preferably at least 20%, preferably at least 22% of the pore volume, particularly preferred 20 to 30% of the total pore volume is formed by pores having a pore diameter of less than 75 Å.

Further preferred, at least 45%, particularly preferred at least 50% of the total pore volume of the clay material used according to the second embodiment of the method according to the invention is provided by pores having a pore diameter of less than 140 Å.

Further, preferably less than 40%, particularly preferred less than 35% of the total pore volume is formed by pores having a pore diameter of more than 250 Å. The clay material used in the second embodiment of the method according to the invention comprises only a low amount of large pores. Nevertheless an efficient purification of crude biodiesel is possible within a time frame acceptable for an industrial application.

In table 2 the preferred share of the pore volume provided by pores having a defined pore diameter is summarized.

TABLE 2
preferred percentages of the total pore volume formed by pores of
a distinct pore diameter for a clay material used in a second embodiment
of the purification method according to the invention

| | | preferred | particularly |
|---|---|---|---|
| pore diameter | | percentage | preferred percentage |
| 0-250 | Å | >55% | 60-80% |
| 0-800 | Å | <90% | 70-85% |
| >800 | Å | <30% | 10-25% |
| 75-140 | Å | <40% | 20-35% |
| 140-250 | Å | <25% | 10-20% |
| 250-800 | Å | <20% | 5-20% |
| 75-800 | Å | <65% | 50-60% |
| >75 | Å | <85% | 60-80% |
| >140 | Å | <60% | 30-50% |
| >250 | Å | <40% | 25-35% |

The clay material is added to the crude biodiesel in an amount of preferably 1 to 5 wt.-%, particularly preferred 0.2 to 5 wt.-%. The percentages refer to the amount of crude biodiesel used in the method according to the invention.

The clay material is added to the crude biodiesel fuel, preferably with stirring. The crude biodiesel is preferably heated to a temperature at or above room temperature. A suitable temperature range is 15 to 100° C., preferably 30 to 80° C. The crude biodiesel is preferably treated at ambient pressure. The crude biodiesel is treated with the clay material for preferably at least 10 min. Longer treatment may be applied, e.g. more than 30 min. A treatment of up to 2 h usually is sufficient. However, longer treatment may be applied, if necessary. After treatment, the spent clay material is separated from the purified biodiesel by known methods, e.g. sedimentation or filtration.

As an alternative, the crude biodiesel may be purified by passing it through a packed column or a filter package each containing the clay material used in the method according to the invention. To avoid a high pressure loss, coarser particles of the clay material are preferably used. Such particles preferably have a particle diameter of 0.1 to 5 mm. Such bigger particles may be obtained by standard granulation techniques, optionally followed by a heat treatment to stabilize the particles.

A crude biodiesel as used in the method according to the invention preferably contains more than 0.02 wt.-% glycerol and/or more than 600 ppmw soaps and/or more than 1000 ppmw water and/or more than 0.2 wt.-% diglycerides and/or more than 0.8 wt.-% monoglycerides, and/or more than 0.02 wt.-% triglycerides. According to a further embodiment, the crude biodiesel comprises an amount of total glycerol of more than 0.23 wt.-%. The term “total glycerol” refers to the sum of free glycerol and glycerol bound in mono-, di- and triglycerides. This amount is determined by standard methods as e.g. defined in European method EN 14 105. In this method gas chromatography is used for determination of total glycerol.

Accordingly, a purified biodiesel as obtained with the purification method according to the invention preferably contains less than 0.02 wt.-%, particularly preferred less than 0.01 wt.-% glycerol, and/or less than 600 ppmw, particularly preferred less than 100 ppmw, most preferred less than 50 ppmw soaps and/or less than 1000 ppmw, particularly preferred less than 500 ppmw water and/or less than 0.2 wt.-%, particularly preferred less than 0.05 wt.-% diglycerides and/or less than 0.8 wt.-%, particularly preferred less than 0.3 wt.-% monoglycerides and/or less than 0.02, preferably less than 0.01 wt.-% triglycerides. According to an embodiment of the invention, the purified biodiesel contains less than 0.23 wt.-%, preferably less than 0.2 wt.-%, most preferred less than 0.1 wt.-% total glycerol.

The particle size of the clay material is adjusted such that the clay material may be separated without difficulties from the purified biodiesel by a suitable method, e.g. filtration, within a suitable time period. The dry residue of the clay material on a sieve of a mesh size of 63 μm preferably is within a range of 20 to 40 wt.-% and the dry residue on a sieve of a mesh size of 25 μm preferably is within a range of 50 to 65 wt.-%. However, the clay material may also be provided in the form of e.g. granules, preferably having a diameter of 1 to 5 mm.

The clay material used in the method of the invention preferably reacts neutral to slightly alkaline. A 10 wt.-% suspension of the clay material in water preferably has a pH in the range of 5.5 to 9.0, particularly preferred 5.9 to 8.7, most preferred 7.0 to 8.5. The pH is determined with a pH-electrode according to DIN ISO 7879.

According to a further embodiment of the method according to the invention, no water wash step is performed on the crude biodiesel before adding the clay material. Due to the high adsorption capacity of the clay material used in this embodiment of the method according to the invention it is not necessary to remove e.g. soaps and glycerol present in the crude biodiesel in a washing step as usual in the currently used purification methods. The adsorption capacity of the clay material is sufficient to remove large amounts of soaps and glycerol.

The crude biodiesel to be purified with the method according to the invention is preferably obtained by transesterification of a triglyceride. The triglycerides may originate from any suitable source for fats and oils, e.g. of vegetable or animal origin, or may be a waste oil or fat. The transesterification may be performed according to known processes. Preferably the alcohol used for alcoholysis of the triglycerides is methanol. However, also other alcohols are suitable, e.g. ethanol or propanol.

According to a further embodiment, the clay material may be used in the method according to the invention in an acid-activated form. Such acid-activated clay material may be used e.g. to remove also traces of an alkaline catalyst together with other impurities, in particular glycerol and mono-, di- and triglycerides from crude biodiesel. The activation may be performed by treating the crude clay material with acid. By the treatment with acid the treated clay material shows an acid reaction. Whereas a 10 wt.-% slurry of the naturally active clay material has a slightly basic pH of preferably 7.0 to 9.0, after acid activation of the clay material a 10 wt.-% slurry has a pH-value of <6.0, preferably 2.5-5.0, particularly preferred 3.0 to 4.5.

According to a first embodiment, activation of the clay material is performed by surface activation, i.e. by depositing an acid on the clay material. Activation may be achieved e.g. by spraying an aqueous solution of an acid onto the crude clay material or by milling the clay material together with a solid acid. The clay material preferably is dried before activation to a moisture content of less than 20 wt.-% H₂O, particularly preferred 10-15 wt.-%. Suitable acids are phosphorous acid, sulphuric acid and hydrochloric acid. A preferred solid acid is citric acid. However citric acid may be used for activation also in the form of an aqueous solution. In this embodiment of the method it is not necessary to remove residual acid deposited on the clay material and salts produced during activation by e.g. washing with water. Preferably after deposition of the acid on the clay material there is not performed any washing step but the acid treated clay material is only dried and then ground to suitable particle size.

In this embodiment of the method according to the invention in a first step an optionally dried crude clay material having the above described features is provided. Onto the clay material is deposited an acid. The amount of acid deposited on the clay material is preferably selected within a range of 1 to 10 wt.-%, particularly preferred 2 to 6 wt.-%, calculated as water-free acid and based on the weight of the dry (water-free) clay material. Surprisingly, the pore volume as well as the surface area of the clay material are about the same as the corresponding values of the crude clay material such that it seems that hardly any salt formation occurs during surface activation. Preferably, during surface activation the specific surface area does not alter for more than 20%, preferably not more than 10%.

According to this embodiment the surface activation of the clay material may also be performed in such a way, that the clay material is activated in an aqueous phase. The clay material, preferably in the form of a fine powder, may be dispersed in water. The acid may then be added to the slurry of the clay material e.g. in the form of a concentrated acid. However, the clay material may also be dispersed in an aqueous solution of the acid. According to a preferred embodiment, the aqueous acid may be sprayed onto the clay material, which is provided in the form of small lumps or of a fine powder. The amount of water used for preparing the diluted acid is selected to be as small as possible. Residual water on the clay material may be removed after acid activation. The humidity of the clay material preferably is adjusted to be less than 20 wt.-%, particularly preferred less than 10 wt.-%. The activated clay material may then be ground to a suitable size.

According to a further preferred embodiment, the crude clay material having the features as defined above is leached with acid, preferably at elevated temperature, particularly at a temperature corresponding to about 5 to 20° C. less than the boiling point of the mixture. Such method is known e.g. from the production of high performance bleaching earth. The leaching is preferably performed with a low amount of acid compared to the amount of acid used in the manufacturing of HPBE. Preferably the amount of acid, calculated as water-free acid and referring to the dried (water-free) clay material, is selected within a range of 15 to 40 wt.-%, particularly preferred 20 to 30 wt.-%. Despite of the low amount of acid used for leaching of the clay a significant increase in adsorption activity is achieved which is comparable to HPBE currently offered on the market.

The leaching of the clay is performed in a usual way. The clay material is cooked with the acid. The time for cooking is selected according to the amount of clay material treated. Usually a leaching period of 2 to 12 h is sufficient to achieve the desired increase in bleaching activity. The slurry of the leached clay material is then filtered and the solid adsorbent material is washed with water to remove salts that have formed during the acid treatment, and residual acid.

Surprisingly, the specific surface area as well as the pore volume is not altered much during acid leaching. The clay material treated with boiling or hot acid has a pore volume and a specific surface area that is preferably not enlarged by more than 20%. As a further advantage, the yield of the acid leaching is quite high. Preferably, the yield is in a range of 80 to 95%, based on the dry clay material. For the acid leaching, preferably strong inorganic acids are used. Particularly preferred acids are sulphuric acid and phosphoric acid.

### EXAMPLES

The following examples are presented in order to more fully explain and illustrate the invention. The examples are not to be construed as limiting the invention.

The physical features used to characterize the adsorbents used in the method according to the invention are determined as follows:

### Specific Surface and Pore Volume

Specific surface and pore volume is determined by the BET-method (single-point method using nitrogen, according to DIN 66131) with an automatic nitrogen-porosimeter of Micrometrics, type ASAP 2010. The pore volume was determined using the BJH-method (E. P. Barrett, L. G. Joyner, P. P. Hienda, J. Am. Chem. Soc. 73 (1951) 373). Pore volumes of defined ranges of pore diameter were measured by summing up incremental pore volumina, which were determined from the adsorption isotherm according BJH. The total pore volume refers to pores having a diameter of 2 to 350 nm. The measurements provide as additional parameters the micropore surface, the external surface and the micropore volume. Micropores refer to pores having a pore diameter of up to 2 nm according to Pure & Applied Chem. Vol. 51, 603-619 (1985).

### Humidity

The amount of water present in the clay material at a temperature of 105° C. was determined according to DIN/ISO-787/2.

### Silicate Analysis

The clay material was totally disintegrated. After dissolution of the solids the compounds were analysed and quantified by specific methods, e.g. ICP.

### a) Sample Disintegration

A 10 g sample of the clay material is comminuted to obtain a fine powder which is dried in an oven at 105° C. until constant weight. About 1.4 g of the dried sample is deposited in a platinum bowl and the weight is determined with a precision of 0.001 g. Then the sample is mixed with a 4 to 6-fold excess (weight) of a mixture of sodium carbonate and potassium carbonate (1:1). The mixture is placed in the platinum bowl into a Simon-Müller-oven and molten for 2 to 3 hours at a temperature of 800-850° C. The platinum bowl is taken out of the oven and cooled to room temperature. The solidified melt is dissolved in distilled water and transferred into a beaker. Then concentrated hydrochloride acid is carefully added. After evolution of gas has ceased the water is evaporated such that a dry residue is obtained. The residue is dissolved in 20 ml of concentrated hydrochloric acid followed by evaporation of the liquid. The process of dissolving in concentrated hydrochloric acid and evaporation of the liquid is repeated once again. The residue is then moistened with 5 to 10 ml of aqueous hydrochloric acid (12%). About 100 ml of distilled water is added and the mixture is heated. To remove insoluble SiO₂, the sample is filtered and the residue remaining on the filter paper is thoroughly washed with hot hydrochloric acid (12%) and distilled water until no chlorine is detected in the filtrate.

### b) Silicate Analysis

The SiO₂ is incinerated together with the filter paper and the residue is weighed.

### c) Determination of Aluminium, Iron, Calcium and Magnesium

The filtrate is transferred into a calibrated flask and distilled water is added until the calibration mark. The amount of aluminium, iron, calcium and magnesium in the solution is determined by FAAS.

### d) Determination of Potassium, Sodium and Lithium

A 500 mg sample is weighed in a platinum bowl with a precision of 0.1 mg. The sample is moistened with about 1 to 2 ml of distilled water and then four drops of concentrated sulphuric acid are added. About 10 to 20 ml of concentrated hydrofluoric acid is added and the liquid phase evaporated to dryness in a sand bath. This process is repeated three times. Finally H₂SO₄ is added to the dry residue and the mixture is evaporated to dryness on an oven plate. The platinum bowl is calcined and, after cooling to room temperature, 40 ml of distilled water and 5 ml hydrochloric acid (18%) is added to the residue and the mixture is heated to boiling. The solution is transferred into a calibrated 250 ml flask and water is added up to the calibration mark. The amount of sodium, potassium and lithium in the solution is determined by EAS.

### Loss on Ignition

In a calcined and weighed platinum bowl about 0.1 g of a sample are deposited weighed in a precision of 0.1 mg. The platinum bowl is calcined for 2 hours at 1000° C. in an oven. Then the platinum bowl is transferred to an exsiccator and weighed.

### Ion Exchange Capacity

The clay material to be tested is dried at 150° C. for two hours. Then the dried material is allowed to react under reflux with a large excess of aqueous NH₄Cl solution for 1 hour. After standing at room temperature for 16 hours, the material is filtered. The filter cake is washed, dried, and ground, and the NH₄ content in the clay material is determined by the Kjedahl method. The amount and kind of the exchanged metal ions is determined by ICP-spectroscopy.

### XRD

The XRD spectra are measured with a powder diffractometer X′-Pert-MPD(PW 3040) (Phillips), equipped with a Cu-anode.

### Determination of the Sediment Volume:

A graduated 100 ml glass cylinder is filled with 100 ml of distilled water or with an aqueous solution of 1% sodium carbonate and 2% trisodium polyphosphate. 2 g of the compound to be analysed is placed on the water surface in portions of about 0.1 to 0.2 g with a spatula. After sinking down of a portion, the next portion of the compound is added. After adding 2 g of the compound to be analysed the cylinder is held at room temperature for one hour. Then the sediment volume (ml/2 g) is read from the graduation.

### Determination of Montmorillonite Proportion by Methylene Blue Adsorption

a) Preparation of a Tetrasodium Diphosphate Solution
5.41 g tetrasodium diphosphate are weighed with a precision of 0.001 g in a calibrated 1000 ml flask and the flask is filled up to the calibration mark with distilled water and shaken repeatedly.

b) Preparation of a 0.5% Methylene Blue Solution
In a 2000 ml beaker, 125 g methylene blue are dissolved in about 1500 ml distilled water. The solution is decanted and then distilled water is added up to a volume of 25 l.

0.5 g moist test bentonite having a known inner surface are weighed in an Erlenmeyer flask with a precision of 0.001 g. 50 ml tetrasodium diphosphate solution are added and the mixture is heated to boiling for 5 minutes. After cooling to room temperature, 10 ml H₂SO₄ (0.5 m) are added and 80 to 95% of the expected consumption of methylene blue solution is added. With a glass stick a drop of the suspension is transferred to a filter paper. A blue-black spot is formed surrounded by a colourless corona. Further methylene blue solution is added in portions of 1 ml and the drop test is repeated until the corona surrounding the blue-black spot shows a slightly blue colour, i.e. the added methylene blue is no longer adsorbed by the test bentonite.

c) Analysis of Clay Materials

The test of the clay material is performed in the same way as described for the test bentonite. On the basis of the spent methylene blue solution is calculated the inner surface of the clay material.

According to this method 381 mg methylene blue/g clay correspond to a content of 100% montmorillonite.

### Determination of Particle Size (Dry Sieve Residue)

Through a sieve cloth, a vacuum cleaner connected with the sieve aspirates over a suction slit circling under the perforated sieve bottom all particles being finer than the inserted sieve being covered on top with an acrylic glass cover and leaves the coarser particles on the sieve. The experimental procedure is as follows: Depending on the product, between 5 and 25 g of air dried material is weighed in and is put on the sieve. Subsequently, the acrylic glass cover is put on the sieve and the machine is started. During air jet screening, the screening process can be facilitated by beating on the acrylic glass cover using the rubber hammer. Exhaustion time is between 1 and 5 minutes. The calculation of the dry screening residue in % is as follows: actual weight multiplied with 100 and divided by the initial weight.

### Apparent Weight

A calibrated 1 l glass cylinder cut at the 1000 ml mark is weighed. By a powder funnel the sample is poured into the cylinder in a single step such that the cylinder is completely filled and a cone is formed on top of the cylinder. The cone is removed with help of a ruler and material adhering to the outside of the cylinder is removed. The filled cylinder is weighed again and the apparent weight is obtained by subtracting the weight of the empty cylinder.

### X-Ray-Diffraction Analysis

1 to 2 g of sample were dry ground by hand in an agate mortar and then passed through a 20 μm sieve. This process was repeated until the entire sample passed the sieve. For the X-ray diffraction measurement a Siemens D5000 equipment was used. The following measuring conditions were employed:

| | |
|---|---|
| Sample holder | Plastic, “top loading”, Ø = 25 mm |
| Thickness of the powder layer | 1 mm |
| X-ray tube | Cu Kα: 40 kV/40 mA |
| Diffraction angles | 2-80° (2 θ) |
| Measuring time | 3 sec per step |
| Slits | Primary and secondary divergence |
| | slits of 1 mm |

Qualitative evaluation of the diffractograms (assignment of the mineral phase was done with a computer program “EVA” by Bruker AXS GmbH, Karlsruhe and according to the publication of Brindley & Brown (1980): Crystal structures of clay minerals and their x-ray identification.—Mineralogical Society No. 5, 495.

The quantitative evaluation was made according to the Rietveld method using the computer program AutoQuan of the company Seifert (GE Inspection Technologies, Ahrensburg, Germany) based on the Rietveld method (see description) for the determination of the content of x-ray amorphous materials zincite as internal standard was added. For the correction the background a polynom of fourth order was used in the angle range of 4-80° in 2 θ.

### Biodiesel Analysis

### a) Acidity Index

The acidity index, provided in mg KOH/g biodiesel is determined according to specification of the American Oil Chemistry Society No. Cd 3d-63.

### b) Free Glycerol and Total Glycerol

Free glycerol and total glycerol are determined according to specification No. Ca 14-56 of the American Oil Chemistry Society.

### c) Soaps

The amount of soaps is determined according to specification Cc 17-79 of the American Oil chemistry Society.

### d) Mono-, di- and Triglycerides

Mono-, di- and triglycerols were determined according to DIN EN 14105.

### Example 1

### General Characterisation of Clay Materials Used for Purification of Crude Biodiesel

The properties of the Clay materials used in the examples according to the invention as well as in the comparative examples are summarized in table 3.

TABLE 3
properties of clay materials

| Adsorbent | 1 | 2 | 3 | comp. 1 | comp. 2 |
|---|---|---|---|---|---|
| Dry sieve residue on | 49 | 55 | 5.2 | n.d. | — |
| 45 μm (%) | | | | | |
| Dry sieve residue on | 35 | 40 | 38 | 40 | 23 |
| 63 μm (%) | | | | | |
| apparent weight (g/l) | 292 | 468 | — | 600 | 550 |
| Methylene blue | 106 | 152 | 179 | 485 | n.d. |
| adsorption (mg/g | | | | | |
| sample) | | | | | |
| Moisture content (%) | 8 | 13 | 12 | 10 | 18 |
| Ph (10 wt.-% in water) | 7.6 | 9 | 8.1 | 8 | 4 |
| cation exchange | 52 | 44 | 53.3 | 90 | 50 |
| capacity (meq/100 g) | | | | | |
| BET surface (m²/g) | 208.4 | 238 | 248 | 71 | n.d. |
| micropore area (m²/g) | 32.1 | 40 | 15 | n.d. | n.d. |
| external surface | 176.3 | 198 | 233 | n.d. | n.d. |
| (m²/g) | | | | | |
| micropore volume | 0.016 | 0.02 | 0.01 | n.d. | n.d. |
| (cm³/g) | | | | | |
| cumulative pore volume | 0.825 | 0.623 | 0.777 | n.d. | n.d. |
| (BJH) for pore diameter | | | | | |
| 1.7-300 nm (cm³/g) | | | | | |
| average pore diameter | 16.4 | 10.0 | 55 | n.d. | n.d. |
| (BJH) (nm) | | | | | |
| sediment volume | 5.5 | 3 | 4 | 6 | 6 |
| (ml/2 g) | | | | | |

In comparative example 2 is used a commercially available surface modified bleaching earth (Tonsil® Optimum 361, aid-Chemie, Peru). In comparative example 1 is used a Ca-bentonite corresponding to the starting material for the production of Tonsil® Optimum 361.

The chemical composition of the adsorbents used in the examples is summarized in table 4.

TABLE 4
Chemical composition of clay materials

| Adsorbent | 1 | 2 | 3 | Comp. 1 | Comp. 2 |
|---|---|---|---|---|---|
| SiO₂ | 70.6 | 69.4 | 69.4 | 57.8 | 61.7 |
| Fe₂O₃ | 2.8 | 3.4 | 3.4 | 2.7 | 5.7 |
| Al₂O₃ | 9.8 | 9.9 | 9.9 | 20.6 | 12.0 |
| MgO | 4.1 | 3.1 | 3.1 | 3.8 | 2.3 |
| CaO | 1.4 | 2.5 | 2.5 | 3.2 | 4.1 |
| K₂O | 1.5 | 1.3 | 1.3 | 0.16 | 0.6 |
| Na₂O | 0.26 | 0.94 | 0.94 | 0.2 | 0.2 |
| TiO₂ | 0.25 | 0.38 | 0.38 | 0.18 | 0.6 |
| SO₃ | — | — | — | — | 6.2 |
| Loi (1000° C.) | 7.9 | 8.1 | 8.1 | 11.2 | 6.2 |

Characterization of clay materials 1 and 2 by X-ray diffraction

X-ray diffraction measurements were made according to the general description for the method. The results are listed in table 5.

TABLE 5
Quantitative mineral phase determination by X-ray diffraction

| Mineral Phase | Adsorbent 1 | Adsorbent 2 |
|---|---|---|
| Smectite (wt.-%) | 40 | 40 |
| Illite/Muscovite (wt.-%) | Traces | n.d. |
| Kaolinite (wt.-%) | n.d. | 1 |
| Sepiolith (wt.-%) | 11 | n.d. |
| Quartz (wt.-%) | Traces | 1 |
| Orthoclase (wt.-%) | 12 | 8 |
| Plagioclase (different) (wt.-%) | 3 | 11 |
| Calcite (wt.-%) | Traces | 1 |
| Amorphous material (wt.-%) | 34 | 38 |

The results from quantitative X-ray diffraction analysis show the presence of smectitic clay in clay materials 1 and 2 as used in the method according to the invention. In addition various side minerals can be found, like sepiolith for clay material 1, orthoclase, plagioclase (other feldspars), calcite. The X-ray diffraction shows the presence of more than 30% of amorphous material for both clay materials. In clay material 2 the amorphous phase is almost present in the same concentration as the smectite (ratio 100:95), whereas in clay material 1 the ratio of smectite to amorphous material is 100:85. These analyses show that the clay minerals used in the method according to the invention exhibit an entirely new structure compared to standard smectites. The presence of the high amount of amorphous material which can be assigned mostly as amorphous silica due to the high SiO₂ content in the silicate analysis explains also the high porosity of the clay materials used in the method of the invention.

### Example 2

### Purification of Crude Biodiesel Obtained from Rapeseed

To 500 to 800 g of a biodiesel sample obtained from rapeseed oil by alcoholysis with methanol were added 0.5 wt.-% adsorbent with stirring. Stirring was continued for 20 minutes while keeping the sample at ambient temperature. The mixture is filtered through a filter paper and the purified biodiesel is analyzed towards the amount of residual glycerol, mono-, di- and triglyceride. The results are summarized in table 6. Also included in table 6 are the limits according DIN EN 14214 and the amounts of contaminants contained in the crude biodiesel.

TABLE 6
amounts of contaminants in crude and purified biodiesel

| | limits | | | |
|---|---|---|---|---|
| | DIN EN | crude | adsorbent | adsorbent |
| | 14214 | biodiesel | 1 | 2 |
| glycerol (wt.-%) | <0.02 | 0.30 | 0.07 | 0.06 |
| monoglycerides (wt.-%) | <0.80 | 0.31 | 0.30 | 0.30 |
| diglycerides (wt.-%) | <0.20 | 0.07 | 0.04 | 0.04 |
| triglycerides (wt.-%) | <0.02 | <0.01 | <0.01 | <0.01 |

As can be seen from table 5, upon addition of 0.5 wt.-% of clay material the amount of residual glycerol in the crude biodiesel can be decreased by up to 80%. Although the amount of residual glycerol is still higher than the upper limit defined in DIN EN 14214 it can be expected that the amount of residual glycerol is further reduced upon increase of the amount of adsorbent used.

### Example 3

### Purification of Crude Biodiesel Obtained from Soybean Oil by Conventional Water Wash Process

A biodiesel sample is obtained from crude soybean oil, i.e. the crude soybean oil was not bleached and deodorized before alcoholysis with methanol. As a comparison a biodiesel is used obtained from bleached and deodorized soybean oil. The crude biodiesel samples are characterized by the parameters summarized in table 7.

TABLE 7
parameters of crude biodiesel obtained from soybean oil

| | biodiesel obtained | biodiesel obtained |
|---|---|---|
| | from crude soybean | from desodorized |
| | oil | soybean oil |
| acidity index (mg | 0.332 | 0.221 |
| KOH/g oil) | | |
| total glycerol (%) | 0.720 | 0.411 |
| residual glycerol | 0.028 | 0.018 |
| (%) | | |
| soaps (ppm) | 617.18 | 60.63 |

As a comparison a water wash was performed on the crude biodiesel obtained from crude soybean oil by washing the crude biodiesel with warm or cold water.

In “water wash 1” 5 wt.-% of water are added to the crude biodiesel and gently agitated for 30 minutes. The biodiesel phase was separated from the aqueous phase and dried by heating the biodiesel to 90° C. at ambient pressure for 1 hour. “Water wash 2” was performed similarly to “water wash 1” but the water used was heated to 60° C. The amount of soaps, glycerol, total glycerol as well as the acidity index are summarized in table 8. Also included in table 8 are the amounts present in the crude biodiesel obtained from crude soybean oil as well as the limits according EN 14214 and ASTM D 6751 specifications.

TABLE 8
Amounts of soaps, glycerol, total glycerol and acidity index of
crude and purified biodiesel obtained from crude soybean oil

| | | | | acidity |
|---|---|---|---|---|
| | soaps | | total | index (mg |
| | (ppm) | glycerol (%) | glycerol (%) | KOH/g oil) |
| crude bio- | 617.18 | 0.028 | 0.528 | 0.332 |
| diesel | | | | |
| water wash 1 | 226.53 | 0.053 | 0.23 | 0.108 |
| water wash 2 | 59.470 | 0.046 | 0.16 | 0.307 |
| EN 14214 | n.s. | 0.02 | 0.23 | 0.8 |
| ASTM D 6751 | n.s. | 0.02 | 0.23 | 0.8 |

### Example 4

### Purification of Biodiesel Obtained from Crude Soybean Oil by Treatment with Adsorbents

500 to 800 g of crude biodiesel obtained by alcoholysis of crude soybean oil with methanol are placed into an Erlenmeyer flask and the respective adsorbents added thereto. The mixture is heated to 60° C. in a water bath for 1 h with stirring. As adsorbents are used clay materials (adsorbents 1 and 4) and, for comparison, a commercially available magnesium silicate (MAGNESOL®, The Dallas Group of America, Inc., USA) and a further commercial product, Trisyl® (Grace inc., Columbia, USA). The samples are filtered to remove the adsorbents and the purified biodiesel is analyzed. The experiments are performed with different amounts of added adsorbents (2.0%, 3.0%, 4.0%). The examples are repeated three times each. The averaged results are summarized in tables 9a to 9c.

TABLE 9a
Amounts of soaps, glycerol, total glycerol and acidity index
of purified biodiesel obtained by adding 2.0 wt.-% adsorbent

| | | | | acidity |
|---|---|---|---|---|
| | soaps | free | total | index (mg |
| | (ppm) | glycerol (%) | glycerol (%) | KOH/g oil) |
| crude bio- | 617.18 | 0.028 | 0.528 | 0.332 |
| diesel | | | | |
| adsorbent 1 | — | 0.013 | 0.081 | 0.107 |
| adsorbent 3 | — | 0.013 | 0.244 | 0.124 |
| Comp. 1 | — | 0.013 | 0.33 | 0.22 |
| Comp. 2 | — | 0.021 | 0.32 | 0.21 |
| MAGNESOL ® | 239 | 0.012 | 0.481 | 0.11 |
| Trisyl ® | — | 0.018 | 0.082 | 0.205 |

TABLE 9b
Amounts of soaps, glycerol, total glycerol and acidity index
of purified biodiesel obtained by adding 3.0 wt.-% adsorbent

| | | | | acidity |
|---|---|---|---|---|
| | soaps | free | total | index (mg |
| | (ppm) | glycerol (%) | glycerol (%) | KOH/g oil) |
| crude bio- | 617.18 | 0.028 | 0.528 | 0.332 |
| diesel | | | | |
| adsorbent 1 | — | 0.005 | 0.077 | 0.112 |
| adsorbent 3 | — | 0.014 | 0.162 | 0.239 |
| Comp. 1 | — | 0.013 | 0.325 | 0.217 |
| Comp. 2 | — | 0.005 | 0.082 | 0.212 |
| MAGNESOL ® | 118 | 0.013 | 0.389 | 0.222 |
| Trisyl ® | — | 0.005 | 0.152 | 0.108 |

TABLE 9c
Amounts of soaps, glycerol, total glycerol and acidity index
of purified biodiesel obtained by adding 4.0 wt.-% adsorbent

| | | | | acidity |
|---|---|---|---|---|
| | soaps | free | total | index (mg |
| | (ppm) | glycerol (%) | glycerol (%) | KOH/g oil) |
| crude bio- | 617.18 | 0.028 | 0.528 | 0.332 |
| diesel | | | | |
| adsorbent 1 | — | 0.021 | 0.040 | 0.157 |
| adsorbent 3 | — | 0.009 | 0.155 | 0.160 |
| Comp. 1 | — | 0.004 | 0.074 | 0.212 |
| Comp. 2 | — | 0.008 | 0.08 | 0.111 |
| MAGNESOL ® | 58 | 0.009 | 0.409 | 0.166 |
| Trisyl ® | — | 0.005 | 0.077 | 0.134 |

By addition of adsorbents the amount of glycerol and total glycerol as well as the acidity index can be reduced in the biodiesel sample. Best results are obtained with adsorbent 1. The purification results in residual amounts for glycerol and total glycerol that are below the limits of specifications according to EN 14124 and ASTM D 6751. A water wash of the crude biodiesel therefore is not necessary, even with only 1 wt.-% dosage.

Adsorbents 1 and 3 used according to the method of the invention show a much better purification performance than the Ca-bentonite (comparison example 1) and the surface modified bleaching earth derived therefrom (comparison example 2). Smectitic clays basically are suitable for biodiesel purification due to their specific interaction with alcohols. Best results, however, are achieved when using a clay material comprising a silica gel matrix within which small smectite platelets are fixed as is used in the method according to the invention. This results in fast adsorption kinetics. In particular at higher dosages, the smectite works better than the corresponding bleaching earth. Although the SMBE has a higher porosity and specific surface, the acid treatment seems to destroy the surface properties which lead to a good adsorption of alcohols.

### Example 5

### Purification of RBD Soybean Oil by Conventional Water Wash Process

Biodiesel obtained from refined, bleached and desodorized (RBD) soybean oil with the parameters as displayed in table 7 is subjected to an adsorbent treatment as described in example 4. For comparison a crude biodiesel sample was purified by a conventional water wash process as described in example 3. The parameters of non-purified as well as of the purified biodiesel are summarized in tables 10a and 10b. Each example was repeated three times. The tables show the averaged results.

TABLE 10a
Characteristic data of the crude biodiesel from
RBD soybean oil before and after water washing
in comparison with EU and US limits for impurities

| | | | Acidity | |
|---|---|---|---|---|
| | Total | Free | Index (mg | Soaps |
| Treatment | glycerol (%) | glycerol (%) | KOH/g oil) | (ppm) |
| Crude bio- | 0.411 | 0.018 | 0.221 | 60.63 |
| diesel | | | | |
| Water-wash 1 | 0.383 | 0.013 | 0.165 | 59.08 |
| Water-wash 2 | 0.159 | 0.0092 | 0.224 | 56.41 |
| EN 14214 | 0.23 | 0.02 | 0.8 | Non specific |
| ASTM D 6751 | 0.23 | 0.02 | 0.8 | Non specific |

TABLE 10b
Purification experiments carried out with 2 wt.-% adsorbent

| | | | acidity | |
|---|---|---|---|---|
| | total | free | index (mg | soaps |
| | glycerol (%) | glycerol (%) | KOH/g oil) | (ppm) |
| crude bio- | 0.411 | 0.018 | 0.221 | 60.63 |
| diesel | | | | |
| adsorbent 1 | 0.1 | 0.0091 | 0.136 | — |
| adsorbent 3 | 0.238 | 0.01 | 0.223 | — |
| Comp. 1 | 0.205 | 0.0137 | 0.164 | — |
| Comp. 2 | 0.248 | 0.01 | 0.111 | — |
| MAGNESOL ® | 0.159 | 0.011 | 0.159 | — |
| Trisyl ® | 0.232 | 0.009 | 0.111 | — |

With 2 wt.-% of adsorbent 1 the total glycerol content is already in specification. Treatment with Magnesol® leads to higher amounts of total glycerol in the biodiesel. All other samples do not lead to an in-spec quality at that dosage. This shows the good performance of the materials used in the method according to the invention.

### Example 6

### Purification of Crude Biodiesel Obtained from Crude Palm Oil

In the example a crude biodiesel is used that had been obtained by alcoholysis of crude palm oil with methanol. The parameters of the crude biodiesel as well as of biodiesel purified by a wash step as described in example 3 are summarized in table 11. Also included are the limits as defined in EU norm and according to ASTM.

TABLE 11
Amounts of soaps, glycerol, total glycerol and acidity index
of crude and purified biodiesel obtained from crude palm oil

| | | | | acidity |
|---|---|---|---|---|
| | soaps | | total | index (mg |
| | (ppm) | glycerol (%) | glycerol (%) | KOH/g oil) |
| crude bio- | n.d. | 0.018 | 0.560 | 0.223 |
| diesel | | | | |
| water wash 1 | n.d. | 0.016 | 0.464 | 0.109 |
| water wash 2 | n.d. | 0.060 | 0.490 | 0.392 |
| EN 14214 | n.s. | 0.02 | 0.23 | 0.8 |
| ASTM D 6751 | n.s. | 0.02 | 0.23 | 0.8 |

The crude biodiesel is purified as described above in example 4 but using crude biodiesel obtained from crude palm oil instead of biodiesel obtained from crude soybean oil.

The results obtained for experiments with 2.0, 3.0 and 4.0 wt.-% adsorbent added are summarized in tables 12 a to 12 c. Each example was repeated three times. The tables show the averaged results.

TABLE 12a
Amounts of soaps, glycerol, total glycerol and acidity index
of purified biodiesel obtained by adding 2.0 wt.-% adsorbent

| | | | | acidity |
|---|---|---|---|---|
| | soaps | | total | index (mg |
| | (ppm) | glycerol (%) | glycerol (%) | KOH/g oil) |
| adsorbent 1 | — | 0.009 | 0.412 | 0.223 |
| adsorbent 3 | — | 0.005 | 0.474 | 0.111 |
| MAGNESOL ® | 126 | 0.014 | 0.495 | 0.223 |

TABLE 12b
Amounts of soaps, glycerol, total glycerol and acidity index
of purified biodiesel obtained by adding 3.0 wt.-% adsorbent

| | | | | acidity |
|---|---|---|---|---|
| | soaps | | total | index (mg |
| | (ppm) | glycerol (%) | glycerol (%) | KOH/g oil) |
| adsorbent 1 | — | 0.005 | 0.386 | 0.334 |
| adsorbent 3 | — | 0.002 | 0.330 | 0.111 |
| MAGNESOL ® | 98 | 0.009 | 0.411 | 0.112 |

TABLE 12c
Amounts of soaps, glycerol, total glycerol and acidity index
of purified biodiesel obtained by adding 4.0 wt.-% adsorbent

| | | | | acidity |
|---|---|---|---|---|
| | soaps | | total | index (mg |
| | (ppm) | glycerol (%) | glycerol (%) | KOH/g oil) |
| adsorbent 1 | — | 0.004 | 0.323 | 0.222 |
| adsorbent 3 | — | 0.002 | 0.247 | 0.111 |
| MAGNESOL ® | 58 | 0.005 | 0.311 | 0.223 |

By using clay materials a purified biodiesel is obtained that satisfies the limits as defined in EU and ASTM norms. A water wash is not necessary.

### Example 7

### Purification of Crude Biodiesel Obtained from Bleached Palm Oil

In the example a crude biodiesel is used that had been obtained by alcoholysis of bleached and desodorized palm oil with methanol. The parameters of the crude biodiesel as well as of biodiesel purified by a water wash step are summarized in table 13. Also included are the limits as defined in EU norm and according to ASTM. All examples were repeated three times. The table shows the averaged results.

TABLE 13
Amounts of soaps, glycerol, total glycerol and acidity index of
crude and purified biodiesel obtained from bleached palm oil

| | | | | acidity |
|---|---|---|---|---|
| | soaps | | total | index (mg |
| | (ppm) | glycerol (%) | glycerol (%) | KOH/g oil) |
| crude bio- | 595.91 | 0.015 | 0.410 | 0.055 |
| diesel | | | | |
| water wash 1 | | | 0.311 | 0.103 |
| water wash 2 | 57.94 | 0.009 | 0.247 | 0.222 |
| EN 14214 | n.s. | 0.02 | 0.23 | 0.8 |
| ASTM 6751 | n.s. | 0.02 | 0.23 | 0.8 |

As can be seen from table 13, after the wash step the amount of soaps and glycerol contained in the purified biodiesel fulfils EU and ASTM norms. However, the amount of total glycerol is above the limit defined in the respective norms. A further purification therefore is necessary.

The crude biodiesel is purified by addition of adsorbent as described in example 4 but using crude biodiesel obtained by alcoholysis of bleached palm oil instead of biodiesel obtained by alcoholysis of crude soybean oil. The adsorbents are used in amounts of 2.0, 3.0 and 4.0 wt.-%. The results are summarized in table 14.

TABLE 14
Amounts of soaps, glycerol, total glycerol and acidity index
of purified biodiesel obtained by adding adsorbents

| | Total glycerol | | | free glycerol | | | acidity index | | |
|---|---|---|---|---|---|---|---|---|---|
| | (wt.-%) | | | (wt.-%) | | | (mg KOH/g oil) | | |
| amt. (wt.-%) | 2.0 | 3.0 | 4.0 | 2.0 | 3.0 | 4.0 | 2.0 | 3.0 | 4.0 |
| Adsorbent 1 | 0.330 | 0.245 | 0.164 | 0.005 | 0.004 | 0.004 | 0.284 | 0.332 | 0.325 |
| Adsorbent 3 | 0.247 | 0.164 | 0.082 | 0.009 | 0.009 | 0.005 | 0.222 | 0.220 | 0.224 |
| MAGNESOL ® | 0.330 | 0.248 | 0.164 | 0.005 | 0.005 | 0.002 | 0.210 | 0.222 | 0.223 |

The amount of soaps contained in the purified biodiesel are not included in the table since the residual amount was close to zero in all samples.

When using the adsorbents in an amount of 4.0 wt.-% the limits as specified in EU and ASTM norms are fulfilled. Adsorbent 3 used according to the invention shows the best results.

1. Method for purifying crude biodiesel, wherein said crude biodiesel is contacted with a clay material, said clay material having:
a surface area of more than 120 m2/g;
a total pore volume of more than 0.35 ml/g;
a silicon content, calculated as Si0₂, of at least 60 wt.-%.

2. Method according to claim 1, wherein the clay material contains more than 10% of amorphous material as determined by quantitative X-ray diffraction analysis of the mineral phases of the clay material.

3. Method according to claim 1, wherein the clay material has an aluminium content, calculated as Al₂0₃, of less than 15 wt.-%.

4. Method according to claim 1, wherein the clay material has a sediment volume in water after 1 h of less than 15 ml/2 g.

5. Method according to claim 1, wherein the clay material has a cation exchange capacity of more than 40 meq/100 g.

6. Method according to claim 1, wherein the clay material contains magnesium, calculated as MgO, in an amount of less than 7 wt.-%.

7. Method according to claim 1, wherein the crude biodiesel contains more than 0.2 wt.-% glycerol.

8. Method according to claim 1, wherein no water washing step is performed on the crude biodiesel.

9. Method according to claim 1, wherein the biodiesel is obtained by alcoholysis of a triglyceride.
